(19) United States
(12) Patent Application Publication
(10) Pub. No.: US 2025/0305385 A1
(43) Pub. Date: Oct. 2, 2025

(54) ROTARY ACTUATED SHEAR AND SEAL VALVE

(71) Applicant: NXL Technologies Inc., Blackfalds (CA)

(72) Inventors: Jonathan Bermillo, Red Deer (CA); Orrin Lind, Springbrook (CA); Jordy Quinn, Red Deer (CA)

(73) Assignee: NXL Technologies Inc., Blackfalds (CA)

(21) Appl. No.: 18/617,665

(22) Filed: Mar. 27, 2024

(51) Int. Cl. E21B 34/02; F16K 5/06; F16K 31/122; F16K 31/524

(52) U.S. Cl. CPC E21B 34/02; F16K 5/0647; F16K 31/122; F16K 31/52458

(57) ABSTRACT

A wellhead valve includes a rotatable valve plug driven by the rotation of a drive stem. The valve further includes complementary camming surfaces that are engaged by rotation of the drive stem and that when engaged create a force on the valve plug that forces a sealing surface of the valve plug into a corresponding sealing surface of a valve seat to thereby create a seal between the sealing surfaces. The valve may include a helical-spline rotary actuator to drive rotation of the drive stem, which in turn drives rotation of the valve plug into (or out of) the sealing position and the complementary camming surface into (or out of) engagement. The rotary actuator may be hydraulic.

### BACKGROUND AND SUMMARY

This invention pertains generally to pressure-control equipment used, for example, in operation of oil/gas wells. More specifically, the invention is directed to technology for an improved wellhead valve for use in downhole operations via, e.g., coiled tubing or wireline.

In one aspect of the invention, a wellhead valve includes upper and lower connector assemblies (e.g., flange assemblies or threaded unions), a rotatable valve plug disposed between the upper and lower connector assemblies, and a valve seat configured to engage the valve plug to form a seal. The valve plug includes a portion to engage a drive stem such that the drive stem may be used to drive rotation of the valve plug. For example, the drive stem may be in the form of pin (or shaft) configured to fit within and engage a box (or socket) on the valve plug such that rotation of the stem causes rotation of the plug. The valve plug (or the drive stem) includes a camming surface configured to engage a corresponding surface of a bearing such that rotation of the valve plug by the drive stem may place the camming surface in intimate contact with the bearing's corresponding cam-engaging surface to force the plug toward the valve seat. For example, the camming surface may be a protuberance (or lobe) extending from a generally cylindrical shaft that is configured to fit and rotate within a generally cylindrical bearing cavity. In one rotation position, the protuberance engages a corresponding bearing surface protruding into the cavity such as to force the valve plug in a direction opposite the point of contact between the protuberance and the corresponding surface. The valve plug includes a sealing surface configured to engage a corresponding sealing surface of the valve seat. In one rotation position of the rotatable valve plug, the plug's sealing surface is forced into the valve seat's sealing surface (via the camming surface engagement with the bearing) to form a seal between the sealing surfaces of the plug and seat without the need for an intervening surface. This enables, e.g., a true metal-to-metal seal that is often desired for harsh conditions.

The wellhead valve may include a means for rotating the drive stem to rotate the valve plug into different rotation positions: an open (unsealed) position which allows fluid (and tools) to pass through the valve into or out of the well and a closed (sealed) position which seals the valve to prevent escape of fluid from the well. For example, a j-slot or helical rotary actuator may be used to convert linear motion into rotation of the drive stem (and thus of the valve plug). A j-slot may include a housing with one or more helical or J-shaped slots that each guide a pin extending from the drive stem. Movement of the housing relative to the drive stem causes rotation of the drive stem as the pins follow the slots. A helical rotary actuator may include a housing having an internal helical spline and a piston having an external helical spline corresponding to the housing's internal helical spline. The piston may be disposed in the housing such that the internal and external splines engage each other. Through engagement of the helical splines, linear movement of the piston within the housing will result in rotation of the piston. The piston is mechanically linked to the drive stem (e.g., through nested linear splines) such that rotation of the piston causes rotation of the drive stem (and thus the plug). In one embodiment of the actuator, the piston and housing form a hydraulic chamber such that differential hydraulic pressure may be used to move the piston within the housing. In one embodiment of the wellhead valve, two hydraulic helical rotary actuators are configured to jointly drive rotation of the valve plug.

The wellhead valve may include one or more shear blades to enable closing of the valve when material is positioned in the valve. For example, wireline or tubing may be placed through the valve to connect surface equipment to equipment disposed in the well. The shear blades are configured to shear through this wireline or tubing in the event that the valve needs to be closed while the equipment is disposed in the well (e.g., an unexpected surge of wellbore fluids). A shear blade may be disposed on the valve plug such that the blade will engage and shear through any material running through the valve when the plug rotates into the sealed position. A shear blade may be disposed in the valve seat such that the blade will engage and shear through any material running through the valve when the plug rotates into the sealed position.

### BRIEF DESCRIPTION OF THE DRAWINGS

These and other features, aspects, and advantages of the present invention will become better understood with reference to the following description, appended claims, and accompanying drawings where:

FIGS. 1A-1C are perspective, front, and top views, respectively, of an exemplary rotary seal valve according to an aspect of the invention.

FIG. 2 is a front sectional view of section A-A of the exemplary rotary seal valve depicted in FIGS. 1A-1C.

FIGS. 3A-3C are perspective, front, and top views, respectively, of portions of an exemplary helical-spline valve-plug actuator in position to create a seal according to an aspect of the invention.

FIGS. 4A-4C are various perspective views of an exemplary valve plug and drive stems according to an aspect of the invention.

FIGS. 5A-5D are various views of an exemplary valve plug with a removable shear blade according to an aspect of the invention.

FIGS. 6A-6B are perspective and side views, respectively, of an exemplary drive-stem/valve-plug bearing according to an aspect of the invention.

FIG. 7 is a sectional view of section B-B of the exemplary actuator depicted in FIG. 3C illustrating an exemplary valve plug seated in an exemplary valve seat to form a seal according to an aspect of the invention.

FIG. 8 is a sectional view of section C-C of the exemplary actuator depicted in FIG. 3C illustrating the engagement of an exemplary valve-plug camming surface with a corresponding surface of a bearing to force the sealing surface of the plug into the valve seat to create a seal according to an aspect of the invention.

FIG. 9 is an exploded perspective view of a shear blade/valve seat assembly, where the valve seat is configured to engage the sealing surface of the valve plug according to an aspect of the invention.

FIG. 10 is a sectional view of section D-D of the exemplary actuator depicted in FIG. 3C illustrating an exemplary valve plug seated in a valve seat to create a seal according to an aspect of the invention.

FIGS. 11A-11C are perspective, front, and top views, respectively, of an exemplary helical-spline valve-plug actuator in position to disengage the seal according to an aspect of the invention.

FIG. 12 is a sectional view of section E-E of the exemplary actuator depicted in FIG. 11C illustrating an exemplary valve plug oriented in an unsealed position according to an aspect of the invention.

FIG. 13 is a sectional view of section F-F of the exemplary actuator depicted in FIG. 11C illustrating the disengagement of an exemplary valve-plug camming surface from a corresponding surface of a bearing to disengage the valve plug from the valve seat according to an aspect of the invention.

FIG. 14 is a sectional view of section G-G of the exemplary actuator depicted in FIG. 11C illustrating an exemplary valve plug in an unsealed position according to an aspect of the invention.

FIG. 15 is a perspective view of an exemplary helical-spline valve-plug actuator in a closed position according to an aspect of the invention.

FIG. 16 is a sectional view of section H-H the exemplary helical-spline valve-plug actuator depicted in FIG. 15 according to an aspect of the invention.

FIG. 17 is a perspective view of an exemplary helical-spline valve-plug actuator in an open position according to an aspect of the invention.

FIG. 18 is a sectional view of section I-I of the exemplary helical-spline valve-plug actuator depicted in FIG. 17 according to an aspect of the invention.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112 (f). Claims that include the “means for [function]” language but also recite the structure for performing the function are not means-plus-function claims governed by § 112 (f). Claims that include the “step for [function]” language but also recite an act for performing the function are not step-plus-function claims governed by § 112 (f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

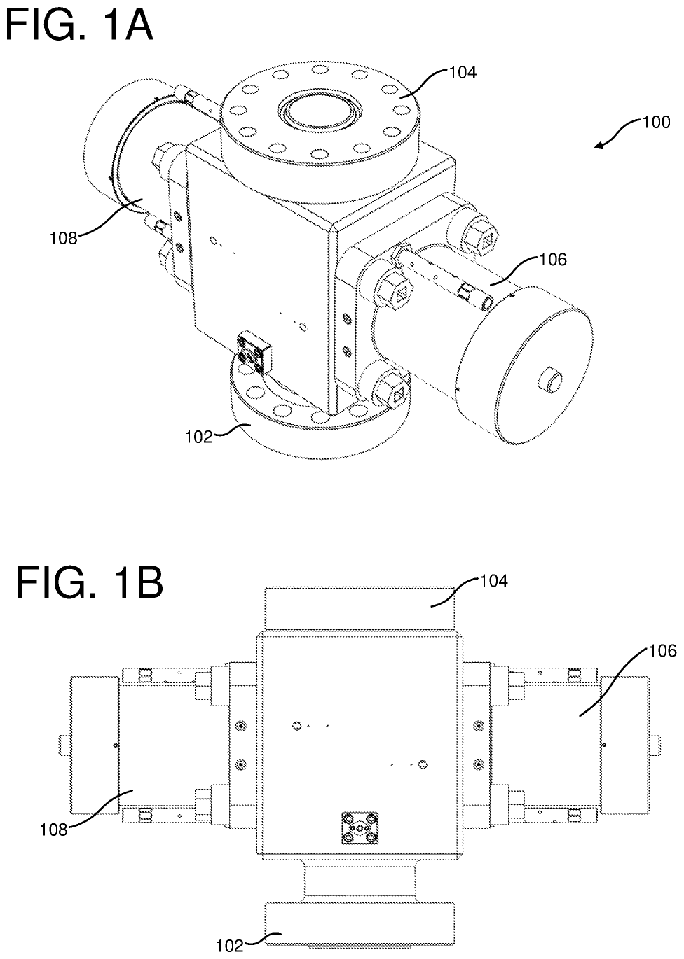

An exemplary rotary seal valve 100 is illustrated in FIGS. 1A-1C, which are perspective, front, and top views respectively. The valve 100 includes flanges 102, 104 to connect to casing, pipes, or other tubulars. (Other connectors, such as threaded unions, may be used without departing from the scope of the invention.) The valve 100 also includes valve-plug actuator mechanisms 106, 108 which are controlled to selectively position a valve plug 120 to open (unseal) or close (seal) the valve 100.

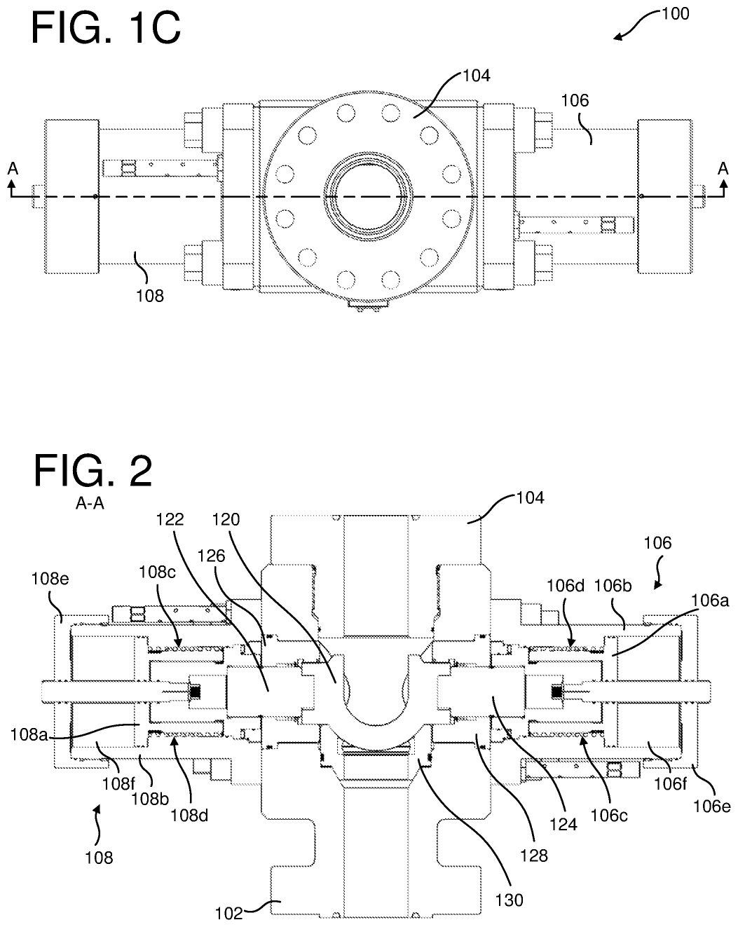

FIG. 2 is a sectional view of section A-A of FIG. 1C depicting the valve 100 with the valve plug 120 oriented in the sealed position. In this embodiment, the valve-plug actuators 106, 108 are hydraulically driven helical-spline actuators, each comprising a hydraulic chamber 106f, 108f defined by a cap 106e, 108e and a housing 106b, 108b. Each actuator includes a piston 106a, 108a disposed within the chamber. The housing 106b, 108b is configured with an internal helical spline 106d, 108d on and inside surface. The piston 106a, 108a is configured with a corresponding external helical spline 106c, 108c on an outside surface. The spline teeth 106c, 108c on the piston 106a, 108a are configured to engage the matching spline teeth 106d, 108d on the housing 106b, 108b such that as the piston 106a, 108a moves linearly within the housing 106d, 108d, the external spline 106c, 108c engages the internal spline 106d, 108d to cause the piston 106a, 108a to rotate about the direction of the linear motion of the piston 106a, 108a. The linear motion is controlled by hydraulic fluid selectively injected into or removed from (or both) the hydraulic chamber to apply a pressure differential on the piston 106a, 108a (as is known in the art of hydraulic cylinders, the piston may be moved via single action or double action). The piston 106a, 108a is mechanically linked to a valve-plug drive stem 122, 124 such that rotation of the piston 106a, 108a causes rotation of the drive stem 122, 123. For example, the piston 106a, 108a and drive stem 122, 124 may be connected through corresponding internal and external linear splines on a hollowed piston 106a, 108a and drive stem 122, 124 respectively. The drive stem 122, 124 is mechanically linked to the valve plug 120 such that rotation of the drive stem 122, 124 causes rotation of the valve plug 120. For example, the drive stem 122, 124 may be configured with a pin (or shaft) portion that engages a box (or socket) portion of the valve plug 120 (or the valve plug 120 may be configured with the pin or shaft and the stem 122, 124 with the box or socket). The drive stems 122, 124 and valve plug 120 are supported by bearings 126, 128. Ultimately, linear motion of the piston 106a, 108a causes rotation of the of the valve plug 120 and can thus be used to place the valve plug in the sealed position (as shown in FIG. 2) or in an unsealed position (e.g., as shown in FIG. 14).

The rotary seal valve 100 includes a valve seat 130 to engage the valve plug 120 and thereby form a seal, as illustrated in FIG. 2.

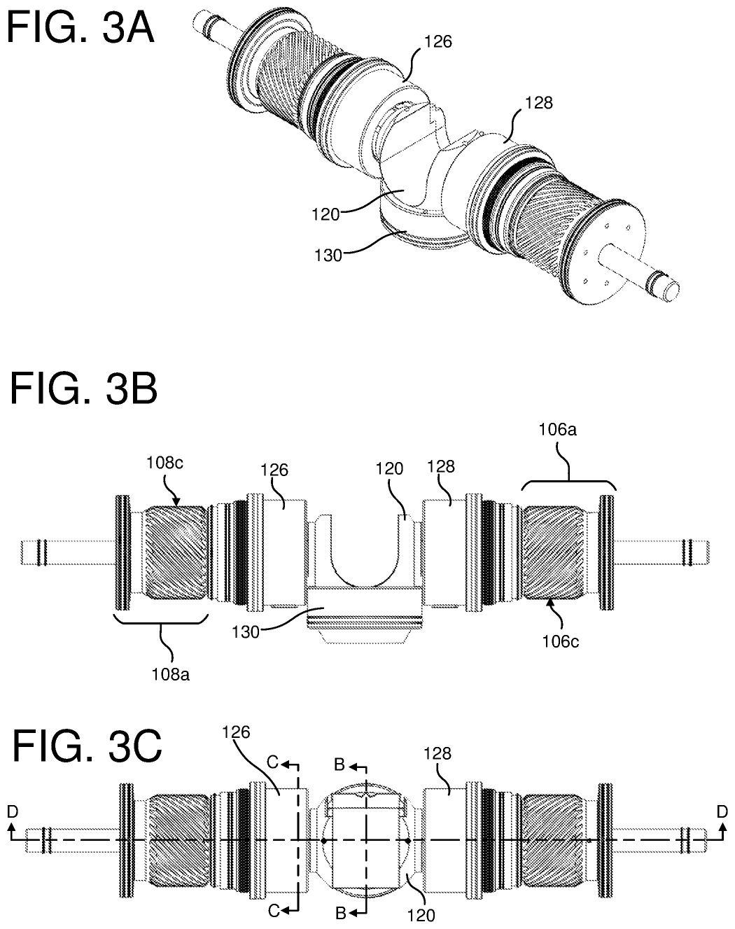

FIGS. 3A-3C are perspective, front, and top views, respectively, illustrating the valve drive mechanism comprising the valve plug 120 and actuators 106, 108, without the caps 106e, 108e and housings 106b, 108b. As depicted, the valve plug 120 is engaged with the valve seat 130 to form a seal.

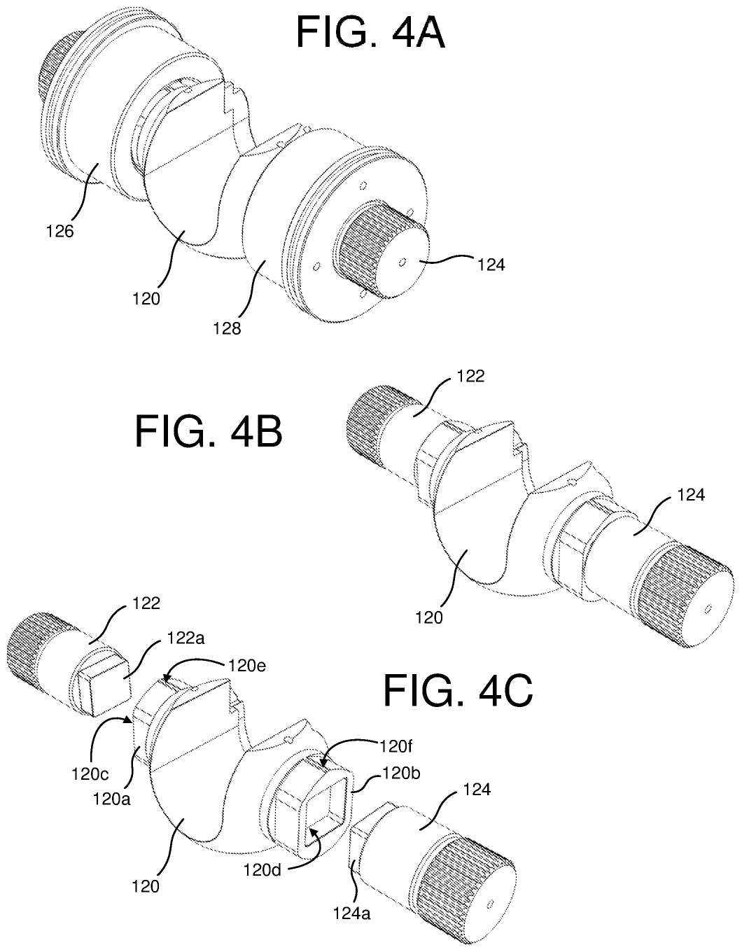

FIGS. 4A-4C are perspective views illustrating the valve plug 120 in various configurations with the drive stems 122, 124 and drive-stem/valve-plug bearings 126, 128. As illustrated, each drive stem 122, 124 includes a pin portion 122a, 124a and the valve plug 120 includes two generally cylindrical protruding stem-engaging portions 120a, 120b. The stem-engaging portions 120a, 120b each include a box 120c, 120d configured to receive the pin portion 122a, 124a of a drive stem 122, 124. The stem-engaging portions 120a, 120b each also include a camming surface 120e, 120f configured to engage a portion of a drive-stem/valve-plug bearing 126, 128 when disposed within the bearing 126, 128 (as depicted in FIG. 4A). When the camming surfaces 120e, 120f are intimately engaged with the bearing 126, 128 in one orientation, the valve plug 120 is forced in the direction opposite the camming surfaces 120e, 120f and into the valve seat 130 to form a seal. (In an alternative embodiment, the drive stems may be provided with a camming surface similar to the plug's camming surfaces 120e, 120f. Engagement of the drive stem's camming surface with the bearing would force the stem toward the valve seat in a similar manner to that described with reference to the primary embodiment. The stem would in turn force the valve plug toward the valve seat to form the seal.)

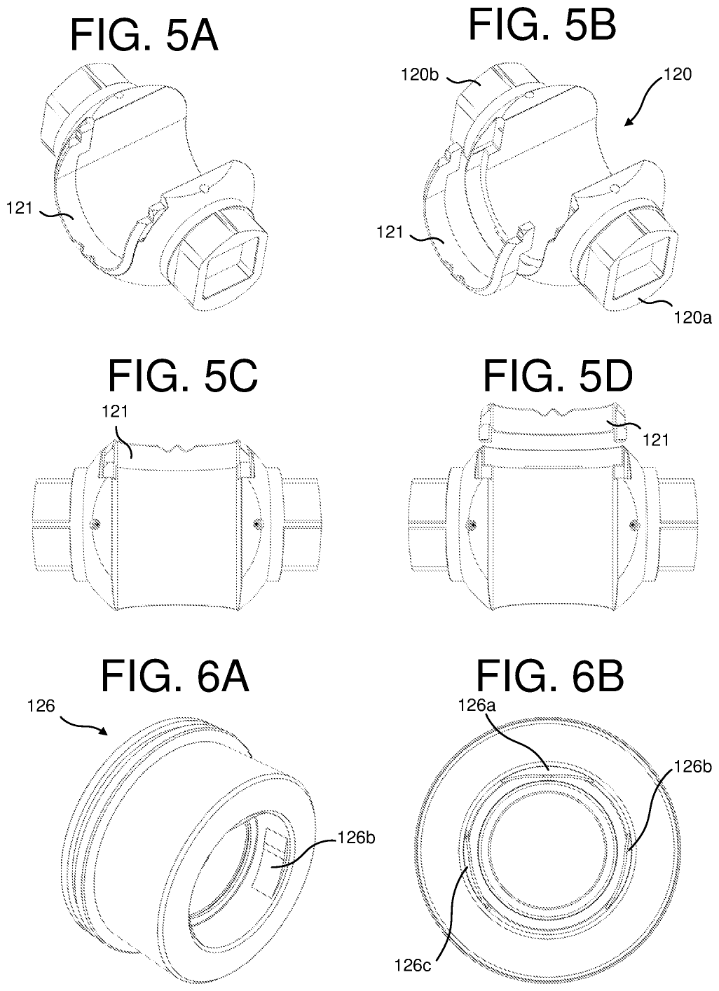

FIGS. 5A-5D are various views of an exemplary valve plug 120 that includes a shearing blade 121. The shearing blade 121 is configured to shear through structure disposed within the valve, such as tubing or a cable, when the valve-plug actuator is activated to rotate the valve plug 130 into the closed position and form the seal. In this exemplary embodiment, the shearing blade 121 is removable (and therefore replaceable).

FIGS. 6A-6B are perspective and side views, respectively, of the exemplary drive-stem/valve-plug bearing 126. As illustrated, the bearing 126 includes features 126a, 126b, 126c that can engage the camming surface 120e, 120f of the valve plug 120. The top camming feature 126a is configured to be positioned in the valve such that engagement of the top feature 126a with the camming surface 120e will force the valve plug 120 into the valve seat 130. The side camming features 126b, 126c are configured to be positioned in the valve such that engagement of a side feature 126b, 126c with the camming surface 120e will force the valve plug 120 off the valve seat 130. (While the bearing of FIGS. 6A-6B is itemized as the left bearing 126 depicted in FIGS. 3A-3C, the right bearing 128 may be identical to the left bearing 126, with similar camming features 128a, 128b, 128c.)

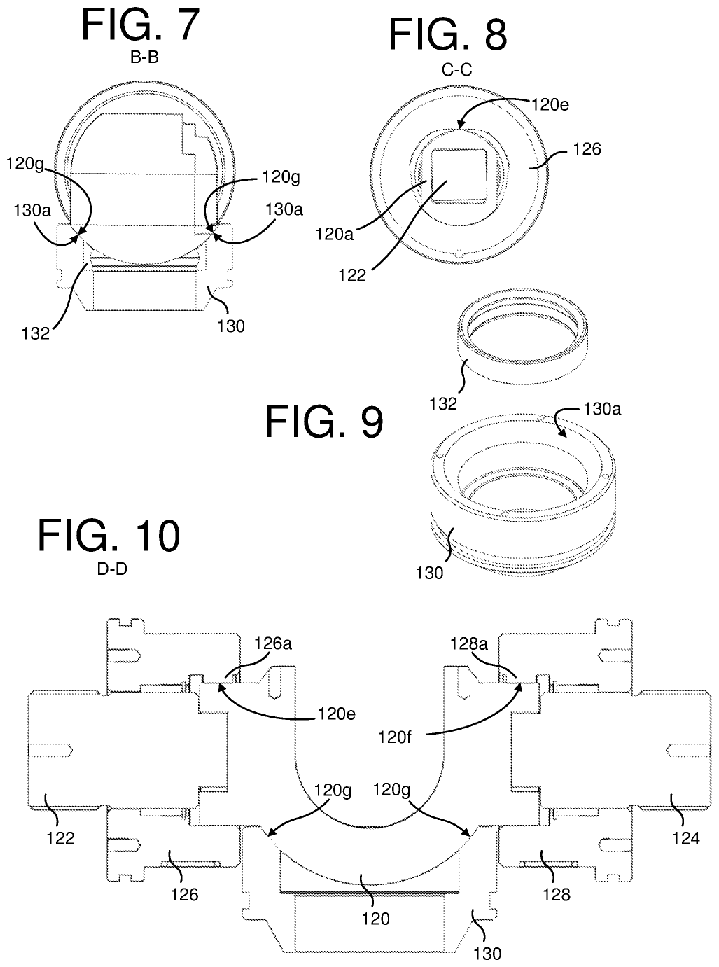

The formation of the seal of the exemplary rotary seal valve 100 can be better understood with reference to FIGS. 7-10. FIG. 7 is a sectional view of section B-B of the actuator illustrated in FIG. 3C. FIG. 8 is a sectional view of section C-C of the actuator illustrated in FIG. 3C. FIG. 9 is an exploded perspective view of an exemplary valve seat 130 and shearing blade 132. FIG. 10 is a sectional view of section D-D of the actuator illustrated in FIG. 3C (showing only select components for sake of clarity). FIG. 7 illustrates a side view of a sealing surface 120g of the valve plug 120 in intimate contact with a sealing surface 130a of the valve seat 130. In this embodiment, a removable shearing blade 132 is positioned in the valve seat 130. FIG. 8 illustrates a side view of a camming surface 120e of the valve plug 120 in intimate contact with the top camming feature 126a of the drive-stem/valve-plug bearing 126. Through the contact of the camming surface 120e with the bearing 126, the valve plug 130a is forced into the seat 130 creating a seal at the contact between the sealing surfaces 120g, 130a of the plug 120 and seat 130. FIG. 10 illustrates a front sectional view of the valve plug 120 forced into the valve seat 130 by the contact of a left-side camming surface 120e with a left bearing camming feature 126a and the contact of a right-side camming surface 120f with a right bearing camming feature 128a.

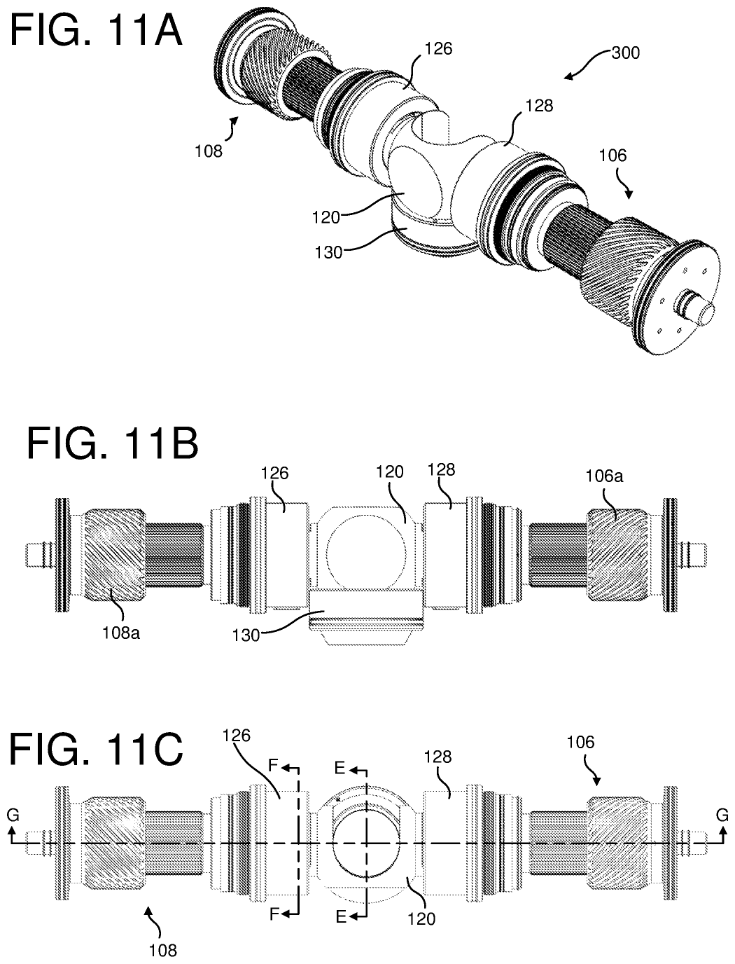

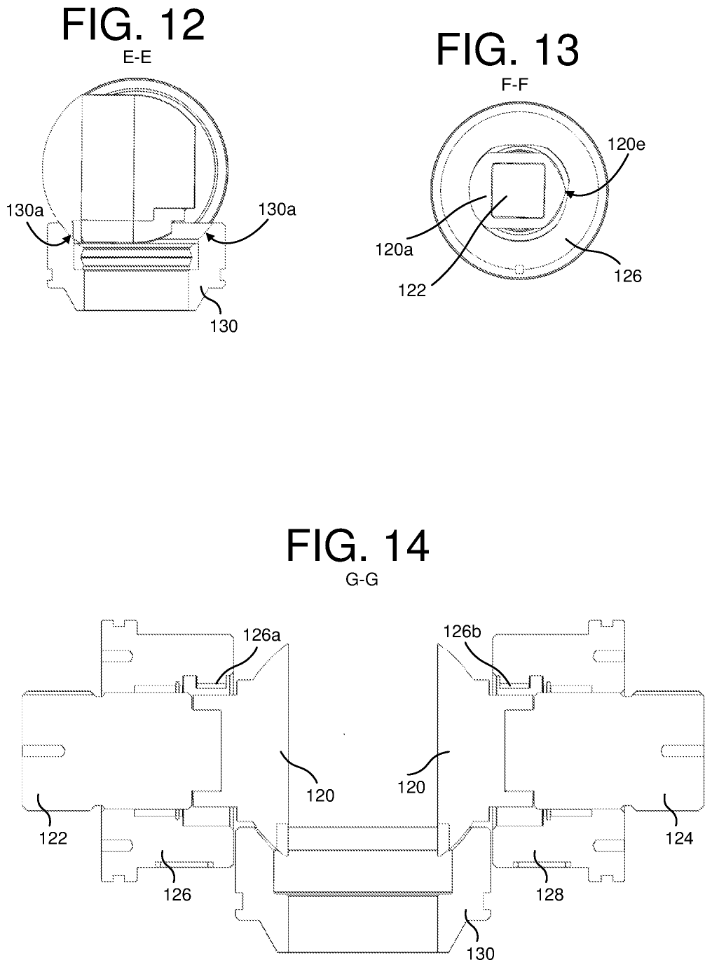

FIGS. 11A-11C are perspective, front, and top views, respectively, illustrating the valve drive mechanism comprising the valve plug 120 and actuators 106, 108, without the caps 106e, 108e and housings 106b, 108b. As depicted, the valve plug 120 is disengaged from the valve seat 130 so that there is not a seal and enabling fluid and equipment to be moved through the valve 100).

FIGS. 12-14 illustrate the seal valve 100 when the valve plug 120 is disengaged from the valve seat 130 so that there is not a seal. FIG. 12 is a sectional view of section E-E of the actuator illustrated in FIG. 11C. FIG. 13 is a sectional view of section F-F of the actuator illustrated in FIG. 11C. FIG. 14 is a sectional view of a portion of section G-G of the actuator illustrated in FIG. 11C (showing only select components for sake of clarity).

FIG. 12 illustrates a side view of the valve plug 120 oriented so that the sealing surface 120g is not in intimate contact with the sealing surface 130a of the valve seat 130. FIG. 13 illustrates a side view of the valve plug 120 oriented so that the camming surface 120e is not in intimate contact with the top camming feature 126a of the drive-stem/valve-plug bearing 126. FIG. 14 illustrates a front sectional view of the valve plug 120 oriented to enable fluid and equipment to move through the valve.

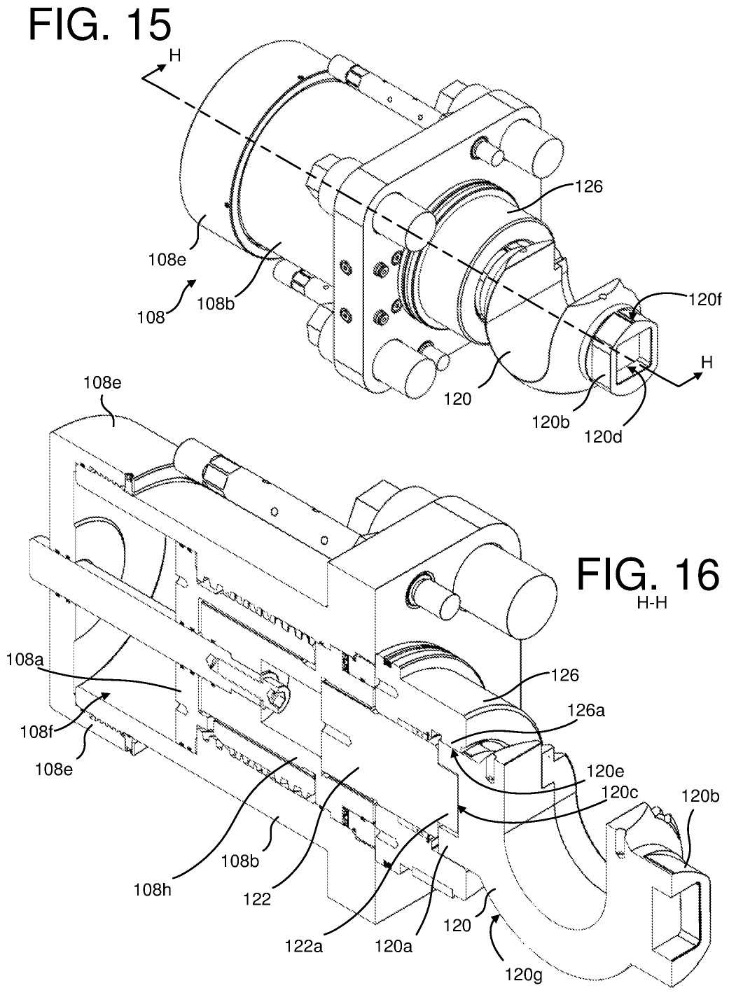

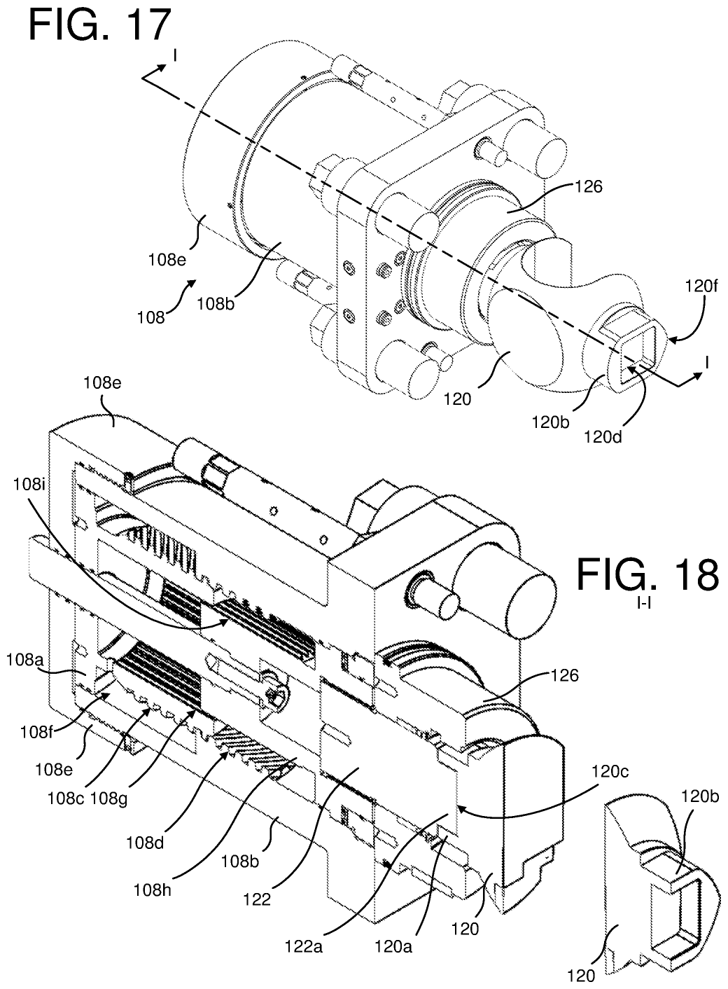

FIGS. 15-16 are perspective and sectional views of an actuator and valve-plug assembly depicted in a “sealed” or closed position and FIGS. 17-18 are perspective and sectional views of an actuator and valve-plug assembly depicted in an “unsealed” or open position. These figures illustrate features of the assembly described with reference to FIGS. 2, 4A-4C, 6A-6B, 10: A hydraulic helical rotary actuator 108 includes a piston 108a disposed in a hydraulic chamber 108f defined by a cap 108e and a housing 108b. The piston 108a includes an external helical spline 108c configured to engage a corresponding internal helical spline 108d of the housing 108b. The piston 108a is hollowed and includes an internal linear spline 108g configured to engage a corresponding external linear spline 108i of a link 108h. The link 108h is configured to engage a valve-plug drive stem 122 (e.g., through corresponding internal/external linear splines on the link 108h and drive stem 122). (In another embodiment, the drive stem may connect directly to the piston, eliminating the link 108h.) The valve-plug drive stem 122 is configured with a pin portion 122a to engage a box portion 120c of a stem-engaging portion 120a of the valve plug 120. Hydraulic pressure in the chamber 108f may be manipulated to linearly move the piston 108a toward the valve plug 120 (and vice versa). As the piston 108a is linearly translated toward the valve plug 120, the helical splines 108c, 108d of the piston 108a and housing 108b engage to cause rotation of the piston 108a about the axis of linear translation. This rotation is communicated through the link 108h to the drive stem 122 and ultimately to the valve plug 120, causing the valve plug 120 to rotate out of (or into) the sealed position. The drive stem 122 and the stem-engaging portion 120a of the valve plug 120 are disposed within a bearing 126. The bearing includes a top protruding cam-engaging feature 126a configured to engage a camming surface 120e of the stem-engaging portion 120a of the valve plug 120. Engagement of the valve plug's camming surface 120e with the bearing's top cam-engaging feature 126a forces the valve plug 120 such that a sealing surface 120g of the valve plug 120 is forced into the valve seat (not shown). This camming force, and the camming features 120e, 126a that operationally enable it, allow for a valve seal between the sealing surface of the valve plug 120 and a sealing surface of the valve seat without intervening material (enabling, e.g., a direct metal-to-metal seal between the metal surfaces of the plug and seat). The camming force further allows orientation of the sealing surfaces toward the high-pressure side of the valve. For example, the valve depicted in FIG. 1A may be connected via the lower flange 102 to a pressurized zone (e.g., the well bore in an oil or gas well) and connected via the upper flange 104 to lower-pressure zone (e.g., a lubricator stack used in a completions or service operations on the well).

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A wellhead valve comprising an upper connector assembly and a lower connector assembly, the valve further comprising:
(a) a rotatable valve plug disposed between the upper and lower connector assemblies, the valve plug comprising:
(i) a first drive-stem-engagement portion,
(ii) a first camming surface, and
(iii) a sealing surface;
(b) a first drive stem connected to the first drive-stem-engagement portion of the rotatable valve plug;
(c) a first bearing including a first cam-engaging surface configured to engage the first camming surface of the rotatable valve plug; and
(d) a valve seat with a sealing surface configured to engage the sealing surface of the rotatable valve plug;
(e) wherein the first camming surface of the rotatable valve plug and the first cam-engaging surface of the first bearing are oriented opposite the sealing surface of the rotatable valve plug and the sealing surface of the valve seat.

2. The wellhead valve of claim 1 further comprising a means for rotating the first drive stem.

3. The wellhead valve of claim 1 further comprising a helical rotary actuator comprising:
(a) a housing with an internal helical spline;
(b) a piston disposed within the housing and including an external helical spline corresponding to the housing's internal helical spline; and
(c) wherein the piston is mechanically linked to the first drive stem such that rotation of the piston results in rotation of the first drive stem.

4. The wellhead valve of claim 3 wherein the housing and piston define a hydraulic chamber.

5. The wellhead valve of claim 1 wherein the first drive-stem-engagement portion of the rotatable valve plug includes a box portion and the first drive stem includes a pin portion configured to fit within the box portion.

6. The wellhead valve of claim 1 further comprising a first shear blade disposed on the valve plug.

7. The wellhead valve of claim 6 further comprising a second shear blade disposed in the valve seat.

8. The wellhead valve of claim 1 wherein the rotatable valve plug includes a second drive-stem-engagement portion and a second camming surface, the wellhead valve further comprising:
(a) a first hydraulic helical rotary actuator comprising:
(i) a first housing with an internal helical spline;
(ii) a first piston disposed within the first housing and including an external helical spline corresponding to the first housing's internal helical spline; and
(iii) wherein the first piston is mechanically linked to the first drive stem such that rotation of the first piston results in rotation of the first drive stem;
(b) a second drive stem connected to the second drive-stem-engagement portion of the rotatable valve plug;
(c) a second hydraulic helical rotary actuator comprising:
(i) a second housing with an internal helical spline;
(ii) a second piston disposed within the second housing and including an external helical spline corresponding to the second housing's internal helical spline; and
(iii) wherein the second piston is mechanically linked to the second drive stem such that rotation of the piston results in rotation of the drive stem; and
(d) a second bearing including a second cam-engaging surface configured to engage the second camming surface of the rotatable valve plug;
(e) wherein the second camming surface of the rotatable valve plug and the second cam-engaging surface of the second bearing are oriented opposite the sealing surface of the rotatable valve plug and the sealing surface of the valve seat.

9. A wellhead valve comprising an upper connector assembly and a lower connector assembly, the valve further comprising:
(a) a rotatable valve plug disposed between the upper and lower connector assemblies, the valve plug comprising:
(i) a first drive-stem-engagement portion,
(ii) a sealing surface;
(b) a first drive stem connected to the first drive-stem-engagement portion of the rotatable valve plug wherein the first drive stem includes a first camming surface;
(c) a first bearing including a first cam-engaging surface configured to engage the first camming surface of the first drive stem; and
(d) a valve seat with a sealing surface configured to engage the sealing surface of the rotatable valve plug;
(e) wherein the first camming surface of first drive stem and the first cam-engaging surface of the first bearing are oriented opposite the sealing surface of the rotatable valve plug and the sealing surface of the valve seat.

10. The wellhead valve of claim 9 wherein the rotatable valve plug includes a second drive-stem-engagement portion, the wellhead valve further comprising:
(a) a second drive stem connected to the second drive-stem-engagement portion of the rotatable valve plug wherein the second drive stem includes a second camming surface;
(b) a second bearing including a second cam-engaging surface configured to engage the second camming surface of the second drive stem;
(c) wherein the second camming surface of second drive stem and the second cam-engaging surface of the second bearing are oriented opposite the sealing surface of the rotatable valve plug and the sealing surface of the valve seat.
